(19) United States
(12) Patent Application Publication
(10) Pub. No.: US 2019/0248217 A1
(43) Pub. Date: Aug. 15, 2019

(54) VEHICLE WINDSHIELD AND SIDE WINDOW SUNSHADE

(71) Applicant: Paul Julian Newton, Hawthorne, CA (US)

(72) Inventor: Paul Julian Newton, Hawthorne, CA (US)

(21) Appl. No.: 15/842,802

(22) Filed: Dec. 14, 2017

(51) Int. Cl. B60J 1/20

(52) U.S. Cl. CPC B60J 1/2091

(57) ABSTRACT

The present invention is a sunshade for a vehicle having the ability to cover the entire windshield and side passenger windows with one piece of material. The sunshade is made from a thin material and is structured with two metal hoops to allow for easy collapsibility of the invention. When fully opened and in place, the sunshade extends beyond the dimensions of the vehicle's windshield and side windows in order to completely block out any space for the sun to pass through. In this opened position, the sunshade attaches to the area above the vehicle's windshield and side windows with Velcro adhesive.

### BACKGROUND

### I. Field

The present invention relates generally to a sunshade for a vehicle.

### II. Background

There are various types of sunshades currently on the market with the aim of blocking out the sun's rays from entering and becoming trapped in a parked vehicle. Many of these sunshades are limited to only covering the front windshield of a vehicle, while some others are limited to only covering the side windows. The few sunshades that attempt to create more expansive coverage tend to be large canopies meant for application around or to the exterior of the vehicle. Further, most sunshades do not claim to completely cover a windshield to block out the sun, instead they allow some sun exposure to pass through the uncovered areas.

When a vehicle is parked under the sun, the sun's rays enter through the vehicle's windows and becoming trapped due to a lack of sufficient energy to escape back out through the windows similar to a greenhouse effect. Most of the attempted solutions to this problem are directed at providing coverage for a vehicle's windshield and do not anticipate the fact that the sun's ray will enter through a vehicle's side windows as well. Some products form an exterior canopy around a vehicle to address this “greenhouse effect,” however, products such as this are a hassle to place around a vehicle, are an unattractive addition to a customer's vehicle, and do not collapse well for easy portable use. In the rare circumstance that a product that does create interior coverage of both the windshield and side windows, this type of product is comprised of multiple independent pieces that must be separately applied to each window when in use and folded when not in use.

Therefore, it would be beneficial to offer a product that could easily be applied to the interior of a vehicle and, in one continuous piece, provide expansive coverage for the entirety of both the windshield and side windows of the vehicle while also being easily collapsible into one small portable carrying case when not in use.

### SUMMARY

The following presents a simplified summary in order to provide a basic understanding of some aspects of the claimed subject matter. This summary is not an extensive overview, and is not intended to identify key/critical elements or to delineate the scope of the claimed subject matter. Its sole purpose is to present some concepts in a simplified form as a prelude to the more detailed description that is presented later.

According to one aspect of the current invention, there are two pieces of material attached to each side of a windshield section of a sunshade so that, when fully expanded, the sunshade provides coverage to the entire windshield and side windows of a vehicle. Alternatively, the sunshade may be made from one continuous piece of material that has been tailored to cover the front windshield and side windows.

According to another aspect, the portion of the sunshade covering the windshield is held in position in the windshield through the use of a flexible wire sewn inside of the windshield portion that allows the windshield portion expand to cover the entire windshield area.

According to another aspect, the portions of the sunshade covering the side windows has a fastening mechanism to attach them to the surrounding areas of the vehicle or to hold them in a position so as to cover the side windows. Alternatively, the portions of the sunshade covering the side windows may be held in place by rolling up a part of the sunshade in the window and allowing the rest of the material to hang down over the window. The material is fitted to extend beyond the dimensions of the windshield and side windows in order to completely block out the sun when attached to the surrounding areas.

According to a further aspect, the sunshade is made from lightweight material that has a reflective UV protectant material on one side and can collapse with its hoop design to fit inside a portable carrying case.

### BRIEF DESCRIPTION OF THE DRAWINGS

FIG. 1 is a general front facing view of the invention;

FIG. 2 is a general back facing view of the invention;

FIG. 3 shows a front view of the invention as it would be used for a big rig truck;

FIG. 4 shows a side view of the invention as it would be used for a big rig truck;

FIG. 5 shows the first step when collapsing the invention, which is to fold under the side pieces;

FIG. 6 shows the second step when collapsing the invention, which is a half-fold;

FIG. 7 shows the fully collapsed invention with a handle for carrying;

### DETAILED DESCRIPTION

In this document, the words “embodiment,” “variant,” and similar expressions are used to refer to a particular apparatus, process, or article of manufacture, and not necessarily to the same apparatus, process, or article of manufacture. Thus, “one embodiment” (or a similar expression) used in one place or context can refer to a particular apparatus, process, or article of manufacture; the same or a similar expression in a different place can refer to a different apparatus, process, or article of manufacture. The expression “alternative embodiment” and similar phrases are used to indicate one of a number of different possible embodiments. The number of possible embodiments is not necessarily limited to two or any other quantity.

The word “exemplary” is used herein to mean “serving as an example, instance, or illustration.” Any embodiment or variant described herein as “exemplary” is not necessarily to be construed as preferred or advantageous over other embodiments or variants. All of the embodiments and variants described in this description are exemplary embodiments and variants provided to enable persons skilled in the art to make or use the invention, and not to limit the scope of legal protection afforded the invention, which is defined by the claims and their equivalents.

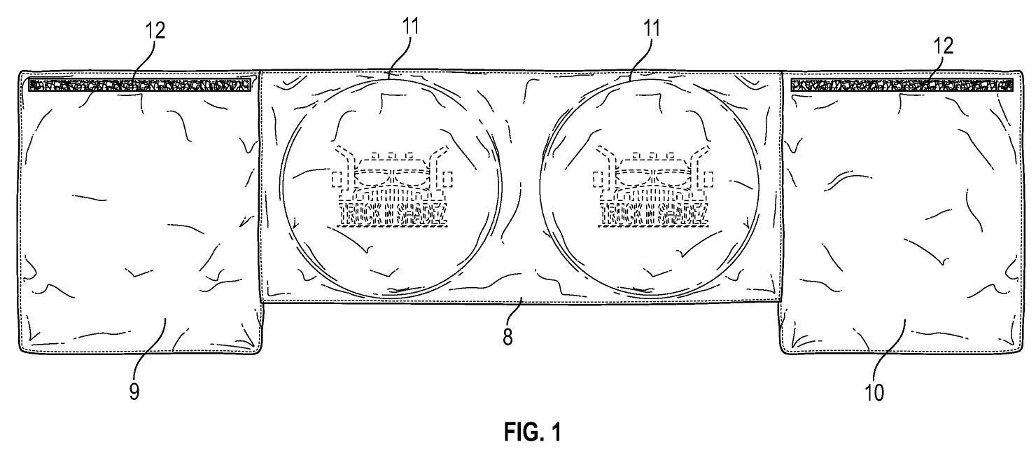

Referring to the figures in the drawings wherein numerals are used to designate elements throughout, FIG. 1 depicts a front view of a preferred embodiment, which includes a windshield cover section 8 into which two flexible wireframes 11 have been sewn, which is attached to a passenger's side window cover section 9 and a driver's side window cover section 10.

In one embodiment of the invention, the passenger's side window cover section 9 and the driver's side window cover section 10 are attached to the vehicle by means of a fastening mechanism 12, which may include but is not limited to the use of Velcro®, adhesive, buttons, zippers, snaps, clips, hooks, or magnets, at the top or sides of each section.

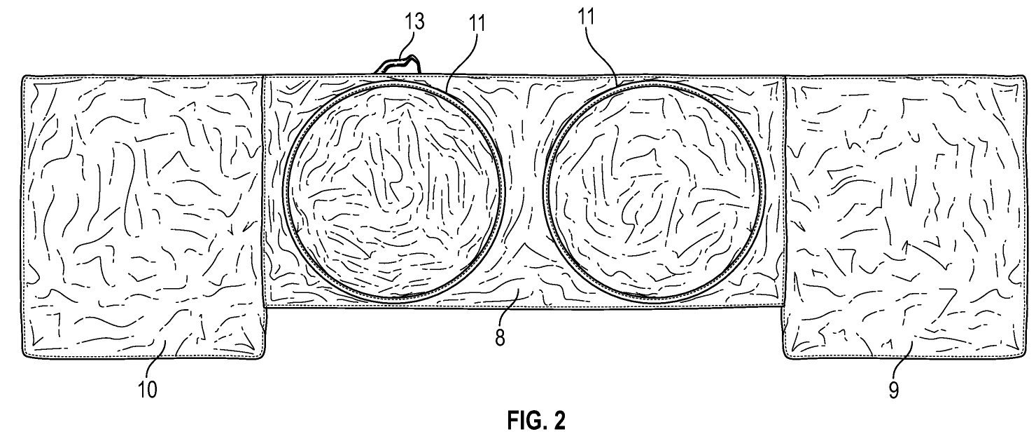

FIG. 2 shows the back view of a preferred embodiment wherein the windshield cover section 8, into which two flexible wireframes 11 have been sewn, is attached to passenger's side window cover section 9 and a driver's side window cover section 10. A handle 13 has been attached to the top side of the windshield cover section 8 for carrying when the invention is folded up.

In one embodiment, one or more flexible wireframes 11 may be attached to or within the windshield cover section 8 to assist in keeping the windshield cover section 8 adjacent to a vehicle's front windshield by expanding to fill the borders of the windshield.

In alternate embodiments, the windshield cover section 8 may take other forms that block sun from entering a vehicle, including but not limited to a single piece of material affixed to the windshield, a draw shade that either pulls up or down along the vehicle's windshield, a horizontal, vertical, or otherwise folding accordion-type sunshade, a sunshade that rolls up or down the vehicle's windshield, a sunshade that collapses along hinges, or a sunshade that is fixed in place.

In alternate embodiments, the passenger's and driver's side window cover sections may take other forms that block sun from entering a vehicle, including but not limited to a single piece of material affixed to the windshield, a draw shade that either pulls up or down along the vehicle's side windows, a horizontal or vertical folding accordion-type sunshade, a sunshade that rolls up or down the vehicle's side windows, or a sunshade that is fixed in place.

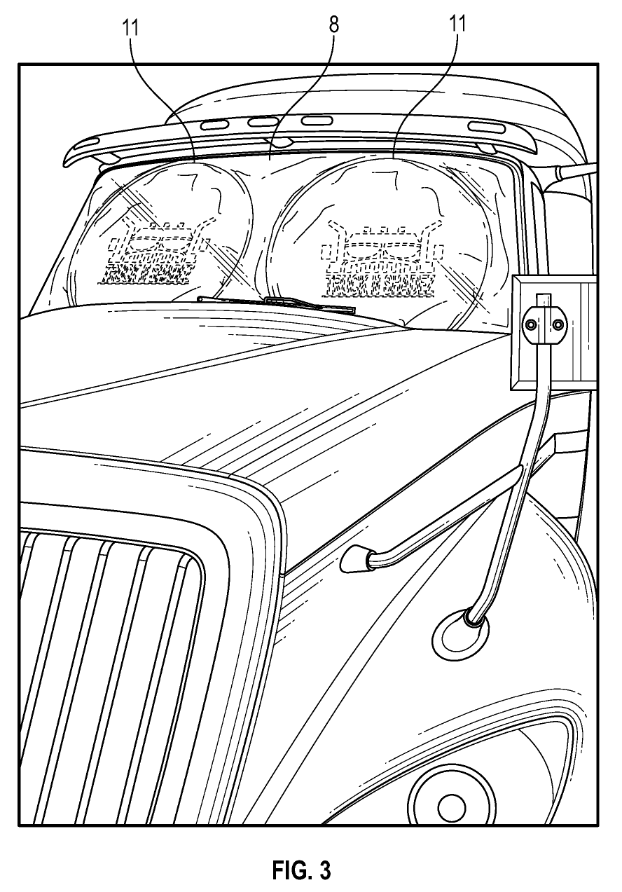

FIG. 3 depicts the front view of an exemplary embodiment of the invention as it would appear in place on a big rig truck, windshield cover section 8 is held in place against the windshield through the use of two flexible wireframes 13.

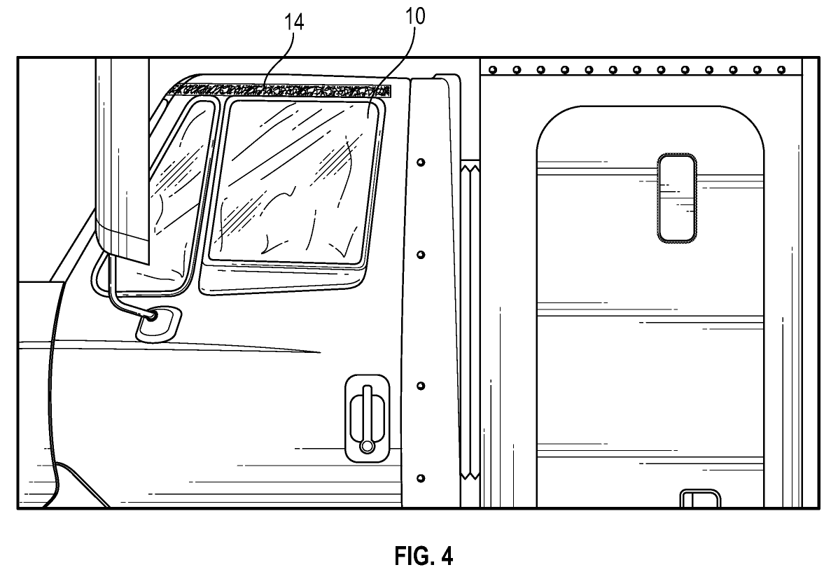

FIG. 4 depicts a left facing view of an exemplary embodiment of the invention as it would appear in place from the driver's side window, wherein the driver's side cover section 10 is affixed to the vehicle by a fastening mechanism 14.

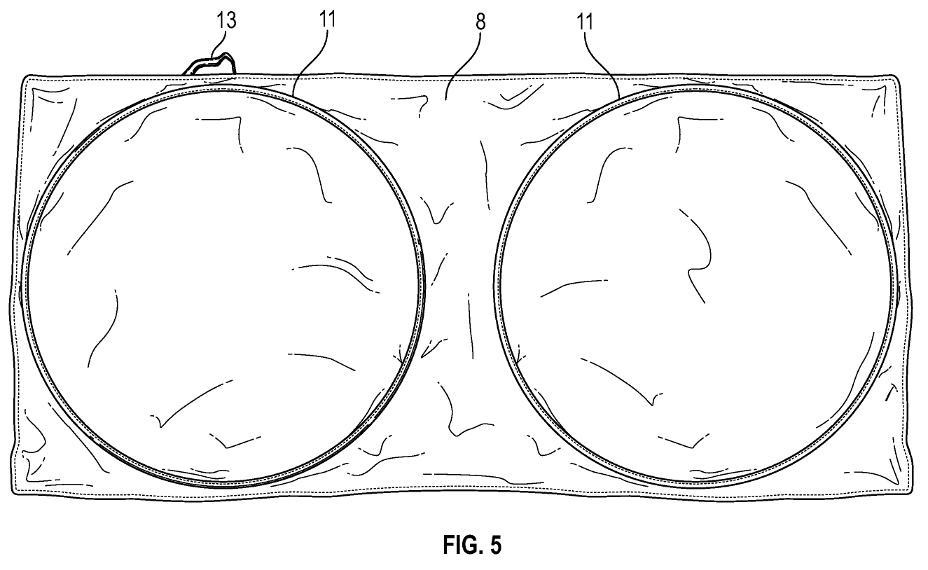

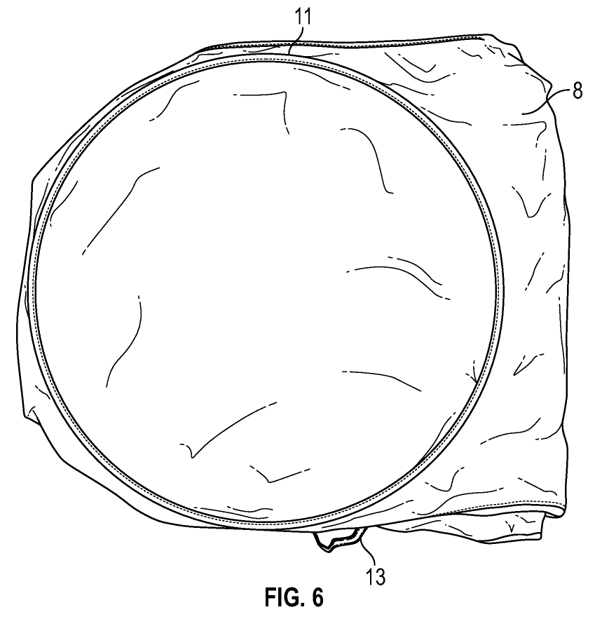

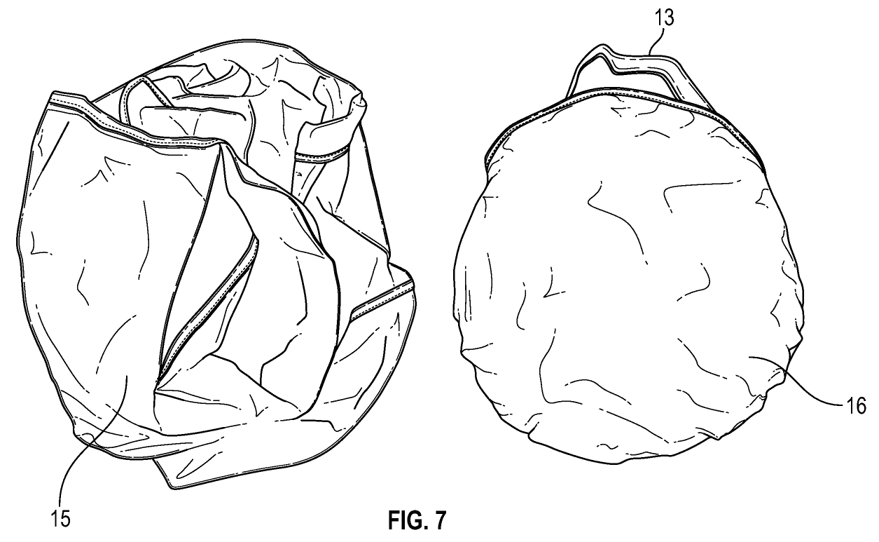

In one embodiment, the invention may collapse or be folded for convenience and portability. FIG. 5 depicts windshield cover section 8 and flexible wireframes 11 folded on top of the passenger's and driver's side window cover sections with handle 13 attached at the top for carrying purposes. FIG. 6 depicts windshield cover section 8 folded in half so that one of the wireframes 11 is folded on top of the other, and the carrying handle 13 can still be accessed. FIG. 7 depicts the entire sunshade in its fully compact state 15 and contained in a storage pouch 16 with handle 13 for carrying said pouch.

In one embodiment, the invention is constructed from a lightweight material, which may include but is not limited to polymer material, nylon, polyester, foil, mesh curtain, cloth, or fabric.

In an alternate embodiment, the invention is constructed from a more rigid material, which may include but is not limited to cardboard, canvas, bubble foil, plastic, metal, tinted adhesive, or netting.

What is claimed is:

1. A sunshade for a vehicle comprised of:
a front windshield section;
a passenger's side window section; and
a driver's side window section;
wherein the passenger's side window cover and the driver's side window cover are attached to the front windshield cover on opposite ends.

2. The sunshade of claim 1, wherein the front windshield section obstructs light from entering the vehicle through the front windshield through the use of one or more flexible wires that span the dimensions of the windshield.

3. The sunshade of claim 1, wherein the front windshield section obstructs light from entering the vehicle by standing upright on the dashboard of the vehicle.

4. The sunshade of claim 1, wherein the front windshield section obstructs light from entering the vehicle by attaching the front windshield section to the front windshield using one or more fastening mechanisms.

5. The sunshade of claim 1, wherein the passenger's side window section obstructs light from entering the passenger's side window through the use of one or more flexible wires that span the dimensions of the side window.

6. The sunshade of claim 1, wherein the driver's side window section obstructs light from entering the driver's side window through the use of one or more flexible wires that span the dimensions of the side window.

7. The sunshade of claim 1, wherein the passenger's side window section obstructs light from entering the passenger's side window by attaching the side window section to a side window using one or more fastening mechanisms.

8. The sunshade of claim 1, wherein the driver's side window section obstructs light from entering the driver's side window by attaching the side window section to a side window using one or more fastening mechanisms.

9. A sunshade for a vehicle comprised of a single sheet of material capable of simultaneously covering the front windshield and both side windows.

10. The sunshade of claim 9, wherein a portion of the sunshade obstructs light from entering the vehicle through the front windshield through the use of one or more flexible wires affixed to a portion of the sunshade that span the dimensions of the windshield.

11. The sunshade of claim 9, wherein a portion of the sunshade obstructs light from entering the vehicle by standing upright on the dashboard of the vehicle.

12. The sunshade of claim 9, wherein a portion of the sunshade obstructs light from entering the vehicle by attaching a portion of the sunshade to the front windshield using one or more fastening mechanisms.

13. The sunshade of claim 9, wherein a portion of the sunshades obstructs light from entering the passenger's side window through the use of one or more flexible wires affixed to a portion of the sunshade that span the dimensions of the passenger's side window.

14. The sunshade of claim 9, wherein a portion of the sunshades obstructs light from entering the driver's side window through the use of one or more flexible wires affixed to a portion of the sunshade that span the dimensions of the driver's side window.

15. The sunshade of claim 9, wherein a portion of the sunshades obstructs light from entering the passenger's side window by attaching a portion of the sunshade to the passenger's side window using one or more fastening mechanisms.

16. The sunshade of claim 9, wherein a portion of the sunshades obstructs light from entering the driver's side window by attaching a portion of the sunshade to the driver's side window using one or more fastening mechanisms.
